(19) United States
(12) Patent Application Publication
(10) Pub. No.: US 2008/0164327 A1
(43) Pub. Date: Jul. 10, 2008

(54) Foldable Document With Non-Contact Electronic Device With Interference Means

(75) Inventors: Yves Eray, Ouistreham (FR); Guy Enouf, Saint-Sylvain (FR)

Correspondence Address: Young & Thompson, 745 S. 23rd Street., Second Floor, Arlington, VA, 22202, US

(73) Assignee: OBERTHUR CARD SYSTEMS SA, Paris (FR)

(21) Appl. No.: 11/994,879

(22) PCT Filed: Jul. 5, 2006
(86) PCT No.: PCT/FR2006/001599

§ 371 Date: Mar. 12, 2008

(30) Foreign Application Priority Data
Jul. 7, 2005 (FR) 0507253

(51) Int. Cl. G06K 19/06

(52) U.S. Cl. 235/492

(57) ABSTRACT

The invention concerns a foldable document comprising a support (10) provided with first and second parts (12, 14) adapted to pivot relative to each other about a folding axis (16) along the edges of (18, 20) of said parts and a non-contact electronic device (1) mounted in the first part (12) of the support and comprising an electronic microcircuit (3) and an antenna (2) electrically connected to said electronic microcircuit (3), and adapted to be (electro)magnetically coupled with an external reading station (5). The quasi-totality of the antenna (2) extends over approximately half of the surface of the first part (12) located proximate the folding axis (16), and the second part (14) is provided with means for disturbing (7) the electromagnetic coupling, arranged substantially perpendicular to the antenna (2) when the first and second parts are substantially superimposed relative to each other, and adapted to disable or enable data exchange externally depending on the angular spacing between the first and second parts.

The present invention concerns making secure the operation of a folding document having an electronic device adapted to the contactless communication technology, as described in the ISO 14443 standard.

It also concerns a folding electronic entity including this kind of contactless electronic device integrated into a folding support, such as a passport, driver's permit or, more generally, an identity document that a bearer might be required to show during identity checks.

It also concerns a document consisting of two parts each formed by a card conforming to the ISO 7816 standard and flexibly connected to each other by one of their sides.

It also finds an application in the contactless communication technology as much as in the dual or hybrid technology, in which the electronic device also has a contact communication interface.

It has already been proposed to integrate into a security document, in practice carrying printed data intended to enable an identity check, a contactless electronic device, for example a microprocessor-based integrated circuit, intended to communicate with the external environment by means of an antenna, to enable contactless exchange of information between the document and an external control station.

The exchange of data is typically effected at the initiative of the reader (the reader sends commands to which the contact electronic device responds).

This kind of security document enables exchange of data richer in information than printed characters or even a photograph, such as biometric data, and, where appropriate, verification of the compatibility between the printed data and the stored data, to detect any attempt to corrupt the printed data.

However, this principle of contactless reading of the data contained in the integrated circuit runs into the understandable reservation that this data can be read unknown to the bearer, by systems that may be unauthorized.

Solutions for preventing such unauthorized reading are already known. For example, the document WO-2005/045754 identifies two reference positions of a document, for example the “open” and “closed” positions, and provides for reading of the data to be possible only in one or the other of those positions. To this end the integrated circuit is connected to at least one coupling element with the external environment and that coupling element is able to exchange information with the external environment or not, depending on the configuration of the security document. In the aforementioned document, the coupling element is an antenna produced on two sheets: the coupling element is operating or not operating an electromagnetic field, depending on the geometry of the antenna and the instantaneous configuration of the document. In a first embodiment, if the antenna has turns each of which is produced in part on each of said sheets, said antenna enables exchange when the document is open (the turns have a maximum exchange area), whereas if the document is closed the halves of each turn are superposed so that they conjointly define a null section, ruling out any exchange with the external environment. A converse situation is obtained if the antenna is made in the shape of an 8, with a crossover of the antenna tracks in line with the fold line between the sheets: in this configuration there can be exchanges only when the document is closed.

However, this kind of security document requires a flexible electrical connection between the two sheets, which is costly and causes reliability problems.

The present invention provides a solution to this problem.

It relates to a folding document including a support having at least first and second portions adapted to pivot relative to each other about a fold line along edges of these portions and a contactless electronic device mounted in the first portion of the support and including an electronic microcircuit and an antenna electrically connected to said electronic microcircuit and adapted to be (electro)magnetically coupled to an external reading station, said electronic microcircuit being adapted to exchange information with the external environment.

According to a general definition of the invention, most of the antenna extends over approximately half of the area of the first portion situated in the vicinity of the fold line, and the second portion is provided with means for disturbing the electromagnetic coupling, disposed substantially in line with the antenna when the first portion and the second portion are substantially superposed one on the other, and adapted to render inoperative or operative the exchange of information with the external environment as a function of the angular offset between the first and second portions.

In practice, the disturbance means comprise means for attenuating the electromagnetic coupling belonging to the group formed by a passive element of the conductor plane type, comprising a chosen pattern, or a circuit forming a resonator, and an active element.

For example, the electronic microcircuit operates at a frequency below 100 MHz, for instance between 13 and 15 MHz, typically equal to approximately 13.56 MHz, and has a bandwidth of the order of 1 MHz.

For example, the antenna extends over almost all of the edge of the first portion along the fold line.

In one embodiment the disturbance means extend over substantially more than half the area of the second portion situated in the vicinity of the fold line.

For example, the disturbance means extend over almost all the edge of the second portion along the fold line.

In a further embodiment, the antenna comprises a conductive winding connected to the electronic microcircuit.

The antenna is of rectangular shape, for example, with the longer side running along the fold line.

In a further embodiment, the geometrical centre of the antenna is placed in the first quarter of the first portion situated relatively close to the fold line.

The right-hand edge of the antenna is situated at a distance from the fold line between 2 and 15 mm, approximately equal to 5 mm, for example.

According to another feature of the invention, the exchange of information with the external environment is rendered inoperative by the attenuation means for an angular offset between 0° and 45°, for example between 0° and 20°.

As a general rule, the document belongs to the group formed by security documents, identity documents, passports, driver's permits.

The present invention also consists in a folding electronic entity including a support having at least first and second portions adapted to pivot relative to each other about a fold line along edges of said portions and a contactless electronic device mounted in the first portion of the support and including an electronic microcircuit and an antenna electrically connected to that electronic microcircuit and adapted to be (electro)magnetically coupled to an external reading station, this electronic microcircuit being adapted to exchange information with the external environment.

According to another aspect of the invention, most of the antenna extends over approximately half of the area of the first portion situated in the vicinity of the fold line, and the second portion is provided with means for disturbing the electromagnetic coupling, coupled to said antenna, and disposed substantially in line with the antenna when the first and second portions are substantially superposed one on the other, and adapted to render the exchange of information with the external environment inoperative or operative as a function of the angular offset between the first and second portions.

The present invention consists finally in a method of controlling exchange of information between a folding document and an external reading station, said folding document including a support having at least first and second portions adapted to pivot relative to each other about a fold line along edges of said portions and a contactless electronic device mounted in the first portion of the support and including an electronic microcircuit and an antenna electrically connected to that electronic microcircuit and adapted to be (electro)magnetically coupled to an external reading station, this electronic microcircuit being adapted to exchange information with the external environment.

According to a further aspect of the invention provision is made so that most of the antenna extends over approximately half of the area of the first portion situated in the vicinity of the fold line, and provision is made to equip the second portion with means for disturbing the electromagnetic coupling, disposed substantially in line with the antenna when the first and second portions are substantially superposed one on the other and the attenuation means render the exchange of information with the external environment inoperative as a function of the angular offset between the first and second portions.

Other features and advantages of the invention will become apparent in the light of the following detailed description and the drawings, in which:

FIG. 1 is a diagram representing the system for processing the signal in the folding document according to the invention;

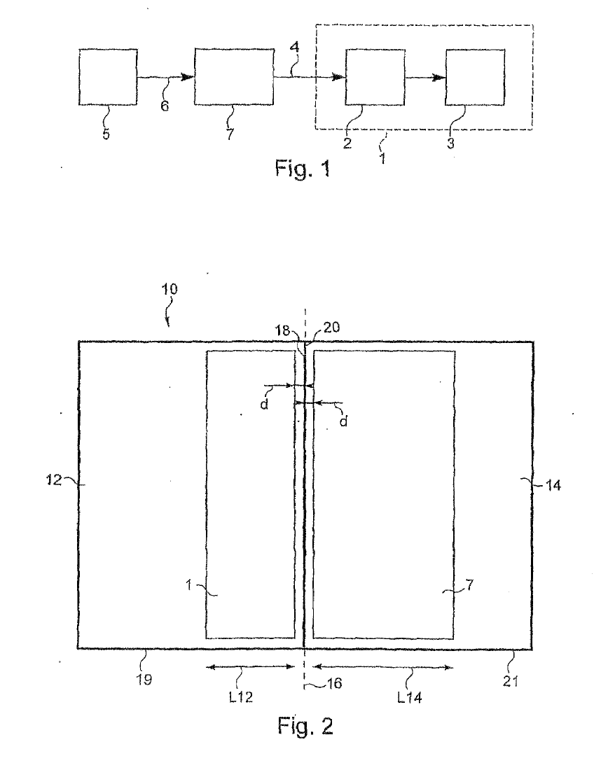

FIG. 2 is a diagram representing the folding document in accordance with the invention in an open position;

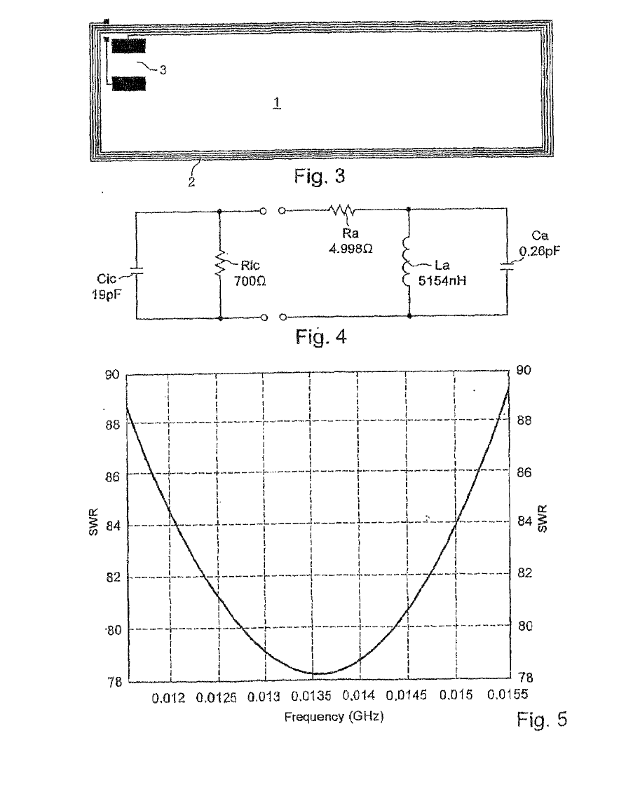

FIG. 3 is a diagram representing a prior art contactless electronic device;

FIG. 4 is an equivalent circuit diagram of the contactless electronic device from FIG. 3;

FIG. 5 is a curve illustrating the SWR of the contactless electronic device from FIG. 3 at the terminals of the loads Ric and Cic of the microcircuit;

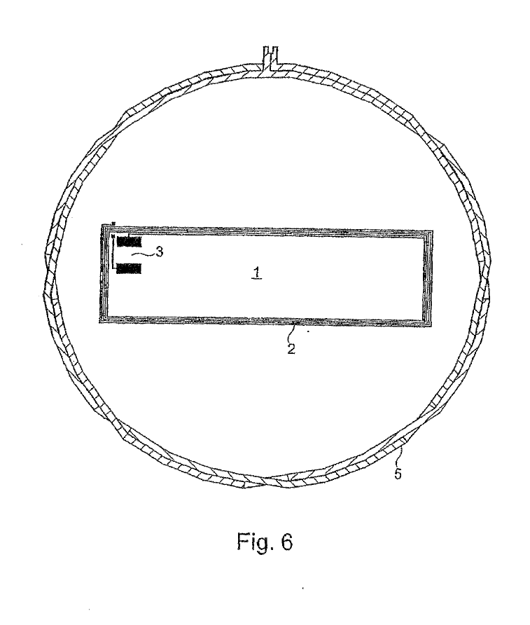

FIG. 6 is a diagram representing the exchange of data between the contactless electronic device from FIG. 3 and an external station according to the prior art;

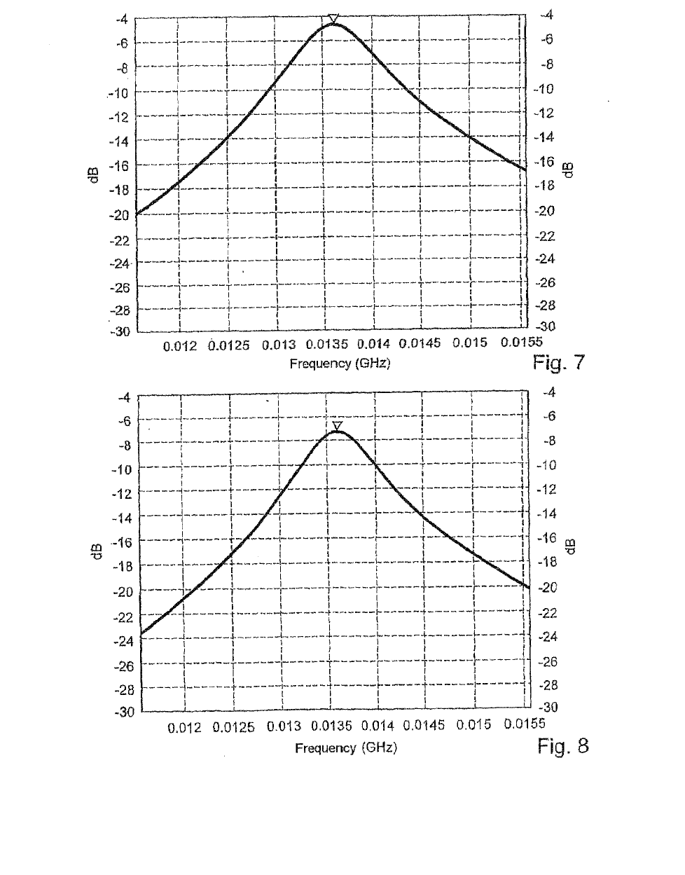

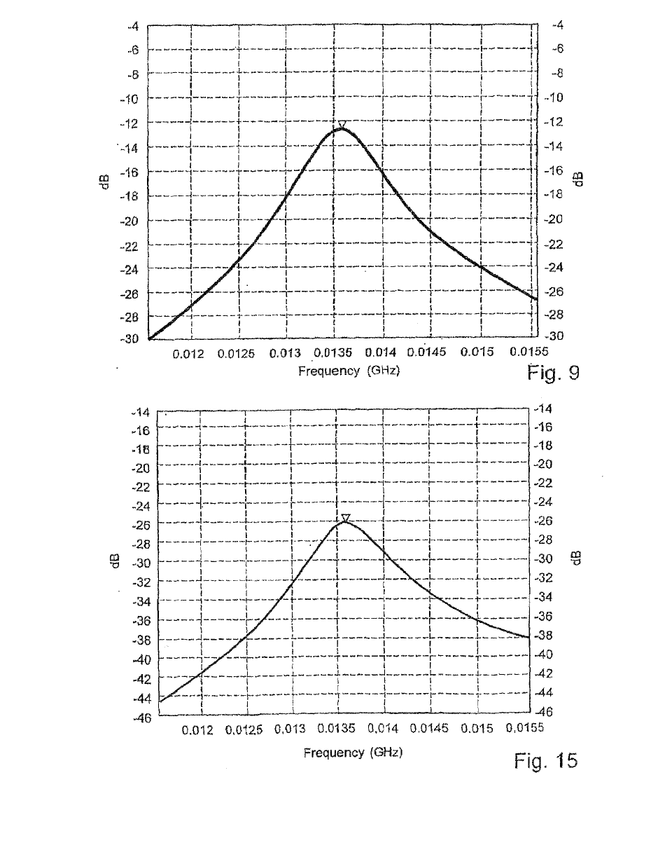

FIGS. 7, 8 and 9 represent the coupling of the elements of a FIG. 6 installation when the reader is situated at a distance respectively corresponding to 0.5 ISO, 1 ISO and 2 ISO, as in the prior art;

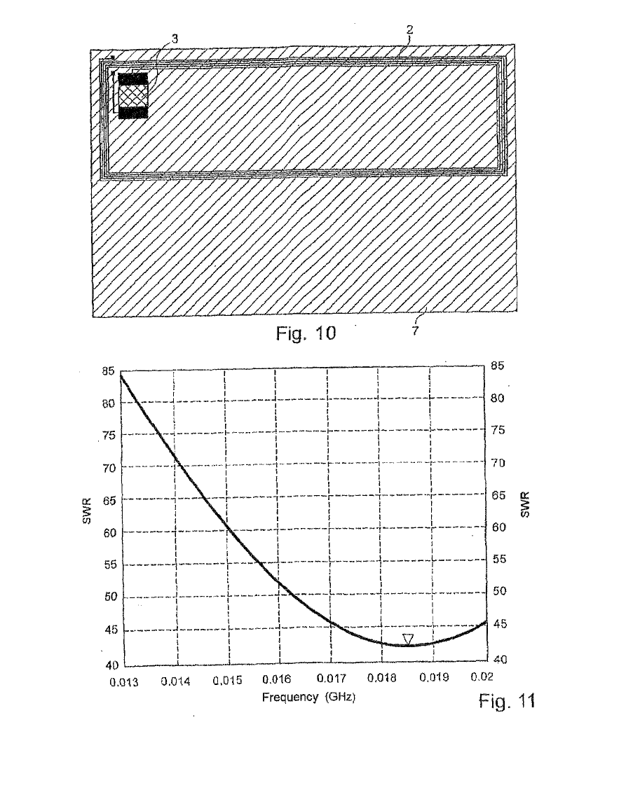

FIG. 10 is a diagram representing a first embodiment of means for disturbing the coupling of the electronic device from FIG. 3 according to the invention;

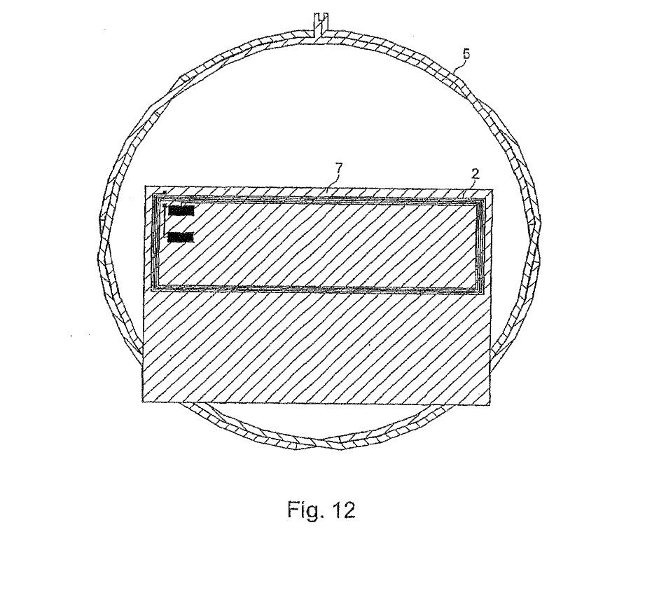

FIG. 11 illustrates the SWR of the installation from FIG. 10 in accordance with the invention;

FIG. 12 represents the contactless electronic device from FIG. 10 disposed in the vicinity of the antenna of a reader according to the ISO 10773 standard;

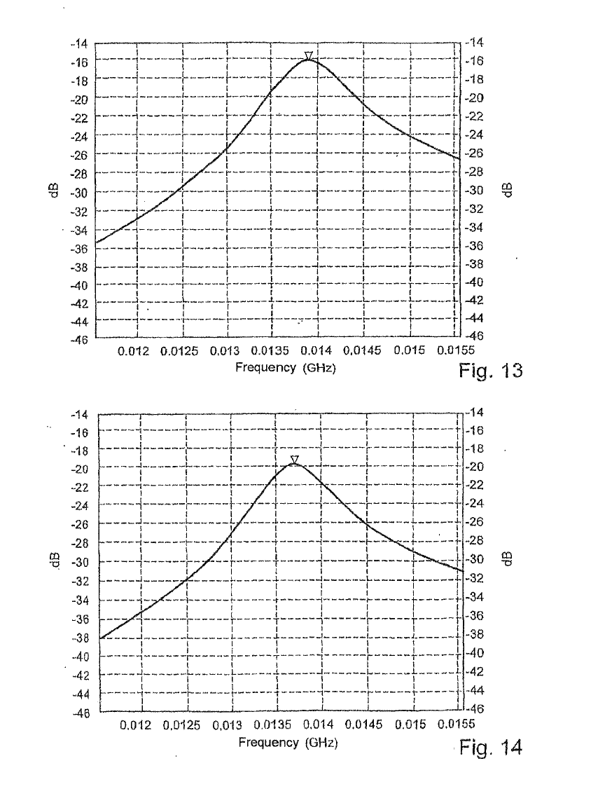

FIGS. 13, 14 and 15 are diagrams representing the coupling of the installation from FIG. 3 when the reader is situated at a distance corresponding to 0.5 ISO, 1 ISO and 2 ISO, respectively, according to the invention;

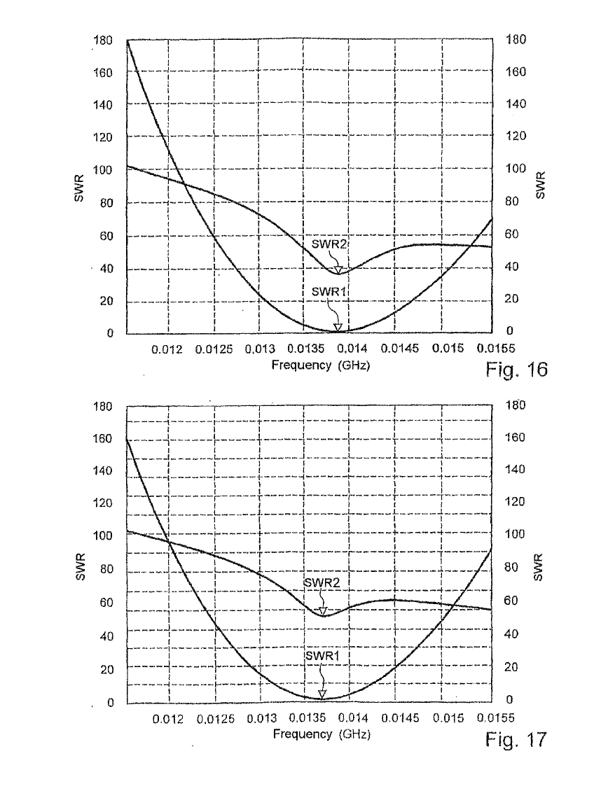

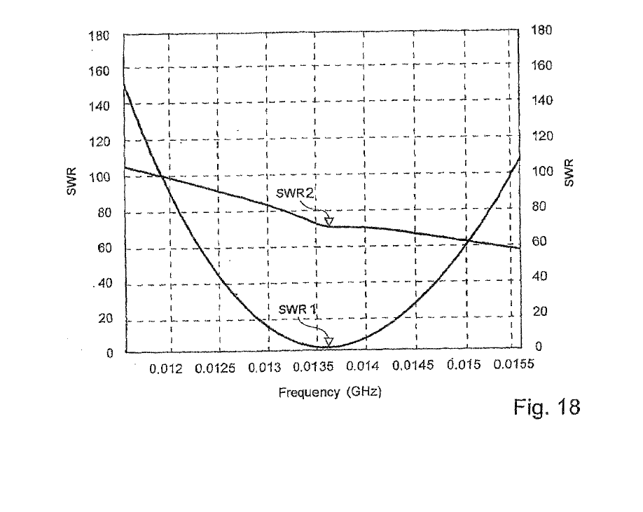

FIGS. 16, 17 and 18 are diagrams representing the SWR of the installation from FIG. 12 when the reader is at respective distances of 0.5 ISO, 1 ISO, and 2 ISO;

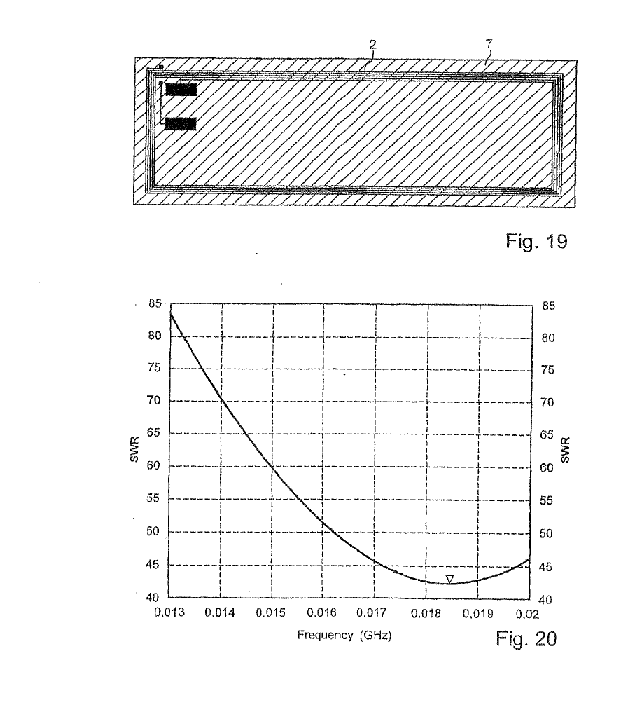

FIG. 19 is a diagram representing a second embodiment of the disturbance means according to the invention;

FIGS. 20 to 23 relating to the second embodiment of the disturbance means according to the invention are similar to the FIGS. 11, 12, 14 and 17, respectively, relating to the first embodiment of the disturbance means; and

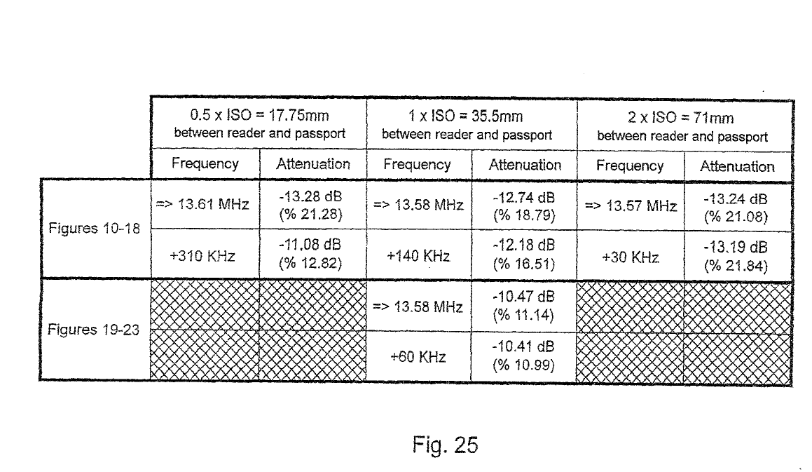

FIGS. 24 and 25 are tables showing different measurements at 0.5 ISO, 1. ISO and 2 ISO.

The following description refers to a security document forming a passport consisting of sheets fastened together along a fold line. Obviously this description based on a passport is in no way limiting on the invention, and can apply to other security documents, such as a driver's permit, an identity card, a transport ticket, a subscription ticket, an access control document.

Referring to FIG. 1, the folding document consists of a contactless electronic device 1 consisting of an antenna 2 and a microcircuit 3 electrically connected to said antenna 2. The antenna 2 is (electro)magnetically coupled to an external station 5.

According to the invention, disturbance means 7 are (electro)magnetically coupled to the antenna 2 to attenuate the signal 6 emitted by the reader 5 and received by the antenna 2 so that the signal 4 coming from the reader 5 and going to the antenna 2 and the microcircuit 3 is attenuated to render the exchange of data between the microcircuit 3 and the station 5 inoperative when the folding document is in a chosen configuration that will be described below.

Referring to FIG. 2, the folding security document comprises a support 10 provided with at least first and second portions 12 and 14 which are adapted to pivot relative to each other about a fold line 16 running along the edges 18 and 20 of the portions 12 and 14, respectively.

The portions 12 and 14 can occupy a plurality of positions between a “closed” position in which said portions 12 and 14 are superposed and the angle between them is 0° and an “open” position in which the angle between the portions is greater than or equal to 90°. The portions 12 and 14 can form the cover of the security document including a plurality of sheets disposed between the two inside faces of said portions 12 and 14. Alternatively, the portions 12 and 14 can constitute any sheets of said security document.

The dimensions of the passport are 125×90 mm, for example. When closed, the thickness of the passport is of the order of 2 mm.

In practice, the contactless electronic device 1 is mounted within the thickness of the first portion 12 of the support 10. The contactless electronic device 1 includes an electronic microcircuit 3 and an antenna 2 electrically connected to said electronic microcircuit 3.

The antenna 2 is (electro)magnetically coupled to the antenna of an external reading station 5. The microcircuit 3 is adapted to exchange information with the external environment.

As indicated with reference to FIG. 1, the countermeasure avoiding fraudulent reading of the document (known as “antiskimming”) consists here in attenuating the signal 6 between the reader 5 and the antenna 2. As will emerge in more detail hereinafter, this attenuation applies essentially to the power aspect of the signal 4. The current generated by the antenna 2 is proportional to the flux generated by the magnetic field of the antenna of the reader 5, and therefore proportional to the attenuation of the disturbance means 7. It is then necessary to verify a certain relative location of the antenna 2 and the disturbance means 7 to guarantee effective attenuation of the signal from the antenna of the reader when the passport is opened.

In practice, the means for attenuating the (electro)magnetic coupling belonging to the group formed by a passive element of the conductor plane type including a chosen pattern, or resonator circuit, and an active element.

In practice the inside face of the portion 14 of the support is equipped with disturbance means according to the invention. Those disturbance means 7 are coupled to the antenna 2 and disposed substantially in line with the antenna when the first and second portions 12 and 14 are substantially superposed one on the other. These attenuation and/or disturbance means render the exchange of information with the external environment inoperative as a function of the angular offset between the portions 12 and 14 of the document 10.

For example, the electronic microcircuit 3 operates at a frequency below 100 MHz, in particular between 13 and 15 MHz, and preferably 13.56 MHz with a range having a width of the order of 1 MHz.

The disposition of the antenna 2 relative to the disturbance device 7 is preferably chosen so that the distance between them is as small as possible when the document opens.

Referring to FIG. 2, it is seen that the antenna 2 occupies virtually all of the edge 18 situated in the vicinity of the fold line 16. On the other hand, this antenna 2 has a limited width L12 along the edge 19 although maintaining sufficient coupling with antenna of the reader. For example, the resonator 7 is chosen so that it occupies the greatest possible area (width L14 along the edge 21 of the portion 14 greater than the width L12 along the edge 19 of the portion 12), for example all of the available area of the sheet 14 of the passport 10.

With a view to obtaining maximum influence between the disturbance element 7 and the antenna 2, the elements 7 and 2 are disposed as close as possible to the fold line 16. This kind of arrangement achieves a small distance between the elements 7 and 2 when the passport is opened, i.e. when the portions 12 and 14 of the passport are pivoted by an angle of more than a few degrees. Communication with the microcircuit is therefore rendered inoperative even in the case of an angular offset of a few degrees.

For example, the right-hand edge of the antenna 2 is situated at a distance d from the fold line 16 between 2 and 15 mm, typically 5 mm, in particular to improve the reliability of the mounting of the various electronic elements of the device according to the invention.

The antenna 2 and the disturbance device 7 can be produced in copper (produced by etching a copper layer previously disposed on the support) or by screenprinting a conductive ink.

The disturbance device 7 and the antenna 2 are preferably produced during the same fabrication step.

In the case of a passport, the antenna 2 and the resonator 7 are in practice produced on an intermediate layer of the cover, that intermediate layer being laminated with other layers to form the cover and to receive the device according to the invention.

Referring to FIG. 3, the contactless electronic device 1 comprises a microcircuit 3 connected to the terminals 26 and 27 of the antenna 2 formed of a conductive winding with a plurality of turns 29.

Referring to FIG. 4, the electronic microcircuit 3 is represented in the conventional way by a resistor Ric and a capacitor Cic in parallel. The resistance of the resistor Ric is 700Ω, for example, and the capacitance of the capacitor Cic is 19 pF. The antenna 2 is represented by the series association of an inductor Lₐ (inductance 5154 nH for example) and a resistor Ra (resistance 4.998Ω, for example). When the antenna 2 is formed of a plurality of turns, the antenna is also modeled with an interturn capacitor Cₐ (capacitance 0.26 pF for example) connected in parallel with the inductor Lₐ.

Referring to FIG. 5, the standing wave ratio (SWR) is represented as a function of frequency. This SWR qualifies the match between the antenna 2 and the microcircuit 3. The match is ideal if the SWR is equal to 1.

Referring to FIG. 6, there is represented the antenna of a reader 5 (antenna station) the parameters whereof (dimensions of the antenna or the reader) conform to the ISO 10373 standard.

Referring to FIGS. 7, 8 and 9, there is represented the coupling between the reader 5 loaded by a resistance of 50 ohms and the antenna 2 loaded by the microcircuit 3, respectively at distances from the reader of 0.5 ISO (18.75 mm), 1 ISO (37.5 mm) and 2 ISO (75 mm).

Note that the frequency at maximum coupling does not vary much if at all.

It should be noted that the microcircuit is designed to operate over a clearly defined range of frequencies Outside that range, the microcircuit does not operate at all, regardless of the power of the received signal. This range is typically centered on 13.56 MHz and substantially extends over less than 1 MHz.

Referring to FIG. 10, there is represented a first embodiment of the disturbance means according to the invention.

The disturbance means take the form of a conductor plane forming a solid rectangle of 120×80 mm. For example, the conductor plane 7 is deposited in the form of a conductive ink by screenprinting.

The conductor plane 7 is represented coupled with the contactless electronic device from FIG. 3. This representation corresponds to the configuration in which the portions 12 and 14 of the support 10 from FIG. 2 are substantially superposed one on the other with the antenna in line with the resonator.

FIG. 11 shows the SWR of the equipment described with reference to FIG. 10.

Note the poor match (SWR=42.22) at the frequency of 18.51. MHz.

FIG. 12 represents the contactless electronic device from FIG. 10 placed in the vicinity of the antenna of a reader conforming to the ISO 1.0773 standard.

FIGS. 13, 14 and 15 represent the coupling between the reader 5 and the antenna 2 at respective distances from the reader corresponding to 0.5 ISO, 1 ISO and 2 ISO.

Note the highest coupling of −15.88 dB at 1.3.92 MHz for 0.5 ISO, the highest coupling of −19.22 dB at 13.72 MHz for 1 ISO, and the highest coupling of −26.45 dB at 13.6 MHz for 2 ISO.

Note also that the frequency at maximum coupling does not vary much if at all.

FIGS. 16, 17 and 18 represent the SWR1 of matching of the reader 5 and the SWR2 of the antenna 2 at respective distances from the reader corresponding to 0.5 ISO, 1 ISO and 2 ISO.

Note, for SWR1, the best match of 1.54 at 13.60 MHz for 0.5 ISO, the best match of 1.25 at 13.58 MHz for 1 ISO and the best match of 1.05 at 13.56 MHz for 2 ISO.

Note, for SWR2, the best match of 3.49 at 13.61 MHz for 0.5 ISO, the best match of 7.07 at 13.59 MHz for a distance of 1 ISO, and the best match of 24.88 at 13.57 MHz for 2 ISO.

Note that the matching of the reader (SWR1) and that of the antenna (SWR2) vary. This is the mutual inductance between the antenna 2 and that of the reader 5 on the one hand and the effect of the disturbance element on the other hand that are the cause of this.

FIG. 19 represents a second embodiment of the disturbance means 7 according to the invention. The resonator 7 comprises a rectangular conductor plane with dimensions of 120 mm×39.5 mm.

Here the disturbance means 7 are disposed relative to the antenna 2 and the microcircuit 3 when the support 10 is closed.

FIG. 20 represents the SWR between the antenna 2 of the contactless electronic device from FIG. 19 and the microcircuit 3. Note the best match of 42.23 at the frequency of 18.46 MHz.

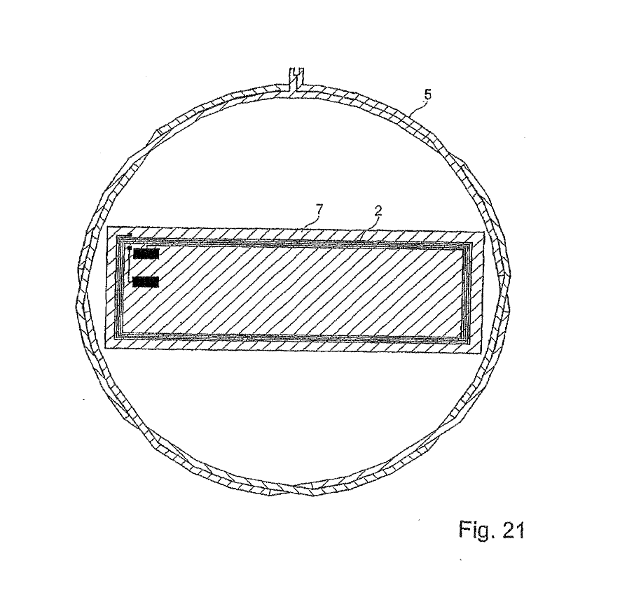

FIG. 21 represents the contactless electronic device from FIG. 19 placed in the vicinity of the antenna of a reader conforming to the ISO 10773 standard.

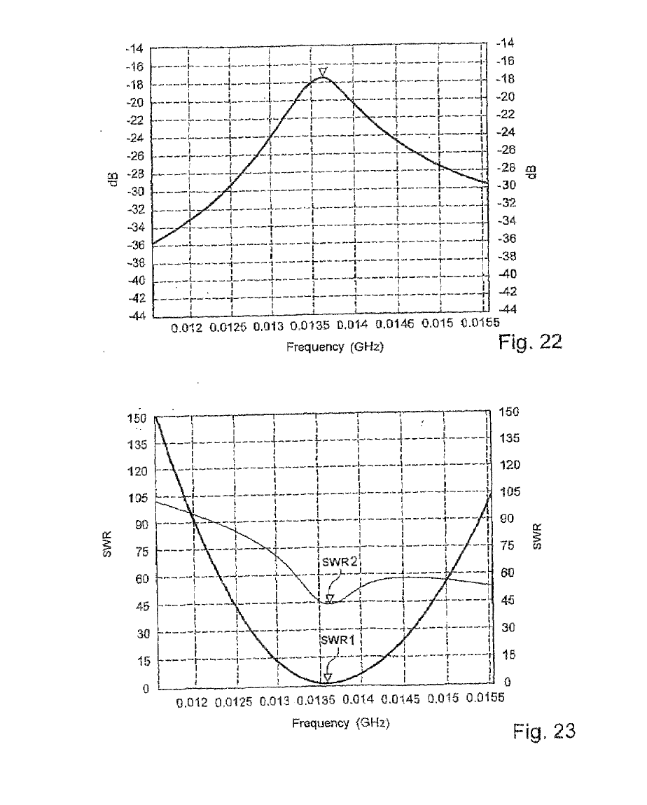

FIG. 22 represents the coupling of the equipment described with reference to FIG. 19 placed at a distance from the antenna of the reader 5 equal to 1 ISO. Note a maximum coupling of −17.45 dB at 13.64 MHz.

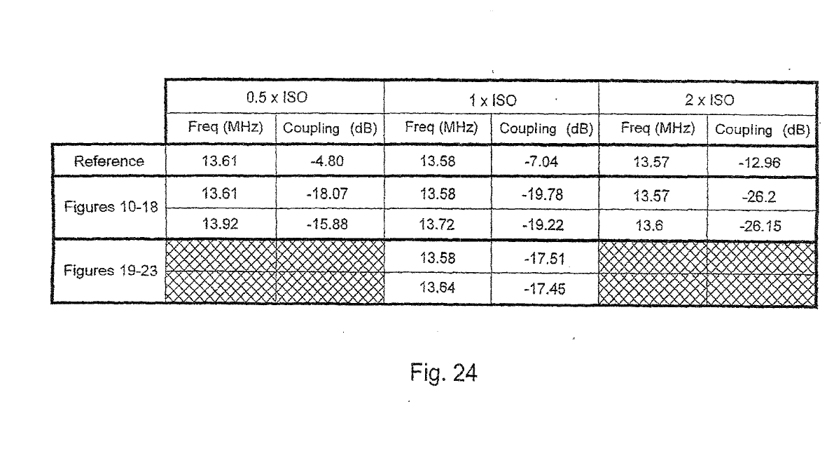

FIG. 23 represents the SWR1 of the matching of the antenna of the reader 5 and the SWR2 of the matching of the antenna 2 at a distance of 1 ISO (37.5 mm).

Note, for SWR1, the best match of 1.54 at 13.60 MHz.

Note, for SWR2, the best match of 43.96 at 13.64 MHz.

FIGS. 24 and 25 represent measurements that show the relative efficacy of the various disturbance means described hereinabove.

For example, non-operation of the microcircuit is obtained up to an opening angle of 20° for a disturber as described with reference to FIGS. 10 to 18.

Such non-operation can be obtained for an angular offset of up to 45° between the portions 12 and 14 of the support 10 (FIG. 2).

1. Folding document including a support (10) having at least first and second portions (12 and 14) adapted to pivot relative to each other about a fold line (16) along edges (18, 20) of said portions and a contactless electronic device (1) mounted in the first portion (12) of the support and including an electronic microcircuit (3) and an antenna (2) electrically connected to said electronic microcircuit and adapted to be (electro)magnetically coupled to an external reading station (5), said electronic microcircuit (3) being adapted to exchange information with the external environment, characterized in that most of the antenna (2) extends over approximately half of the area of the first portion (12) situated in the vicinity of the fold line (16), and in that the second portion (14) is provided with means (7) for disturbing the electromagnetic coupling, disposed substantially in line with the antenna (2) when the first portion (12) and the second portion (14) are substantially superposed one on the other, and adapted to render inoperative or operative the exchange of information with the external environment as a function of the angular offset between the first and second portions (12 and 14).

2. Document according to claim 1, wherein the antenna (2) extends over most of the edge (18) of the first portion along the fold line (16).

3. Document according to claim 1, wherein the disturbance means (7) comprise electromagnetic coupling attenuation means of the type belonging to the group formed by a passive element of the conductor plane type including a chosen pattern, an active element of the resonator circuit type.

4. Document according to claim 3, wherein the quasi-totality of the disturbance means (7) extend over substantially more than half the area of the second portion (14) situated in the vicinity of the fold line (16).

5. Document according to claim 4, wherein the disturbance means (7) extend over the quasi-totality of the edge (20) of the second portion along the fold line (16).

6. Document according to claim 3, wherein the disturbance means comprise a conductor plane printed on the second portion in a conductive ink.

7. Document according to claim 1, wherein the electronic microcircuit (3) operates at a frequency below 100 MHz.

8. Document according to claim 7, wherein the frequency is between 13 and 15 MHz.

9. Document according to claim 8, wherein the frequency is approximately 13.56 MHz and has a bandwidth of the order of 1 MHz.

10. Document according to claim 1, wherein the antenna (2) comprises a conductive winding connected to the electronic microcircuit.

11. Document according to claim 1, wherein the antenna (2) is of rectangular shape, with the longer side along the fold line.

12. Document according to claim 1, wherein the geometrical center of the antenna (2) is placed in the first quarter of the first portion (12) situated relatively close to the fold line (16).

13. Document according to claim 1, wherein the right-hand edge of the antenna (2) is situated at a distance (d) from the fold line (16) between 2 and 15 mm.

14. Document according to claim 13, wherein said distance (d) is approximately 5 mm.

15. Document according to claim 1, wherein the exchange of information with the external environment is rendered inoperative by the attenuation means (7) for an angular offset between 0° and 45°.

16. Document according to claim 15, wherein the exchange of information with the external environment is rendered inoperative by the attenuation means (7) for an angular offset between 0° and 20°.

17. Folding electronic entity including a support (10) having at least first (12) and second (14) portions adapted to pivot relative to each other about a fold line (16) along edges (18, 20) of said portions and a contactless electronic device (1) mounted in the first portion (12) of the support and including an electronic microcircuit (3) and an antenna (2) electrically connected to that electronic microcircuit (3) and adapted to be (electro)magnetically coupled to an external reading station (5), this electronic microcircuit (3) being adapted to exchange information with the external environment, characterized in that most of the antenna (2) extends over approximately half of the area of the first portion (12) situated in the vicinity of the fold line (16), and in that the second portion (14) is provided with means for disturbing the electromagnetic coupling coupled to said antenna, and disposed substantially in line with the antenna (2) when the first and second portions (12 and 14) are substantially superposed one on the other, and adapted to render the exchange of information with the external environment inoperative or operative as a function of the angular offset between the first and second portions.

18. Method of controlling exchange of information between a folding document and an external reading station (5), said folding document including a support (10) having at least a first portion (12) and a second portion (14) adapted to pivot relative to each other about a fold line (16) along edges (18, 20) of said portions and a contactless electronic device (1) mounted in the first portion (12) of the support and including an electronic microcircuit (3) and an antenna (2) electrically connected to that electronic microcircuit (3) and adapted to be (electro)magnetically coupled to an external reading station (5), this electronic microcircuit (3) being adapted to exchange information with the external environment, characterized in that provision is made so that most of the antenna (2) extends over approximately half of the area of the first portion (12) situated in the vicinity of the fold line (16), and in that provision is made to equip the second portion (14) with means (7) for disturbing the electromagnetic coupling, disposed substantially in line with the antenna when the first portion and the second portion are substantially superposed one on the other, and in that the attenuation means (7) render the exchange of information with the external environment inoperative or operative as a function of the angular offset between the first and second portions.

19. Document according to claim 1, wherein the document belongs to the group formed of security documents, identity documents, passports, driver's permits.

20. Document according to claim 2, wherein the antenna (2) comprises a conductive winding connected to the electronic microcircuit.
